(19) United States
(12) Patent Application Publication
(10) Pub. No.: US 2011/0165282 A1
(43) Pub. Date: Jul. 7, 2011

(54) MOLDING APPARATUS

(75) Inventors: Yoichiro KOJIMA, Toyota-shi (JP); Masanori OGAWA, Toyota-shi (JP); Masaki RYUUGAKU, Toyota-shi (JP); Hideki NISHIJIMA, Toyota-shi (JP); Tetsuaki MOTOSUGI, Toyota-shi (JP)

(73) Assignee: KOJIMA PRESS INDUSTRY CO., LTD., Toyota-shi (JP)

(21) Appl. No.: 12/979,910

(22) Filed: Dec. 28, 2010

(30) Foreign Application Priority Data
Jan. 7, 2010 (JP) 2010-001864

(51) Int. Cl. B29C 33/00

(52) U.S. Cl. 425/404

(57) ABSTRACT

An apparatus for performing a predetermined machining operation on a material and performing an injection molding operation of resin on the surface of the material includes a machining mechanism for performing the predetermined machining operation. The machining mechanism includes a holding device, such as a mold for holding the material when the predetermined machining operation, such as a press forming operation, is performed on the material. In a state in which the material is held by the holding device, there is defined a molding space for molding the resin between the surface of the material and the inner surface of a mold member arranged to be opposed to the surface of the material. A resin flow path is provided for communication between the exterior of the molding space and the molding space. An injection mechanism can injecting molten resin into the molding space via the resin flow path.

This application claims benefits of priority to Japanese patent application serial number 2010-001864 filed on Jan. 7, 2010, the contents of which are incorporated herein by reference in its entirety for all purposes.

### STATEMENT REGARDING FEDERALLY SPONSORED RESEARCH OR DEVELOPMENT

Not applicable.

### BACKGROUND OF THE INVENTION

1. Field of the Invention

Embodiments of the invention relate to a molding apparatus that can perform a predetermined machining on a material and can perform injection molding of resin on the material.

2. Background of Technology

A bracket 70 shown in FIG. 9 is an automotive component retaining a battery provided as an auxiliary battery to be used when a main battery is damaged in an automobile or to be used for emergency communication when an accident or the like has occurred. The bracket 70 is formed through pressing (bending) a plate-shaped metal material into a predetermined configuration, and sheets 72 formed of felt, resin or the like are attached through manual operation to the surface of the bracket on which the battery is to be placed. The sheets 72 can prevent the battery from movement and generating noise. And, by selecting resin, which is less expensive than felt, as the material of the sheets 72, it is possible to achieve reduction in material cost. However, the manual operation step may constitute a significant factor of increase in cost.

The manual operation step may be performed by an apparatus for molding resin on the surface of the metal material as disclosed in Japanese Laid-Open Patent Publication Nos. 05-200877, 11-179755 and 11-254481.

In the case that the resin molding apparatus as disclosed in these publications is employed, an additional apparatus cost is required, and an additional space for installation of the apparatus is necessary, which means that reduction in cost is rather hard to achieve.

Therefore, there is a need in the art for a molding apparatus that does not require a manual operation step and can suppress the apparatus cost and the requisite installation space.

### SUMMARY OF EMBODIMENTS OF THE INVENTIONS

A molding apparatus for performing a predetermined machining operation on a material and performing an injection molding operation on a surface of the material includes a machining mechanism for performing the predetermined machining operation. The machining mechanism includes a holding device, such as a jig or a mold, that can hold the material when performing the predetermined machining operation of the material. In a state in which the material is held by the holding device, there is defined a molding space for molding resin between the surface of the material and an inner surface of a mold member arranged to be opposed to the surface of the material. There is provided a resin flow path for communication between the exterior of the molding space and the molding space. There is provided an injection mechanism capable of injecting molten resin into the molding space via the resin flow path.

With this construction, it is possible to perform the machining operation on the material and to also perform the injection molding operation of resin on the surface of the material by using a single processing equipment during a single processing step. Thus, as compared with the case in which separate units of processing equipment are individually installed, it is possible to suppress the equipment cost and the installation space, and to achieve reduction in cost through elimination of need of a manual operation process.

Further, in this apparatus, constituting the mold member by a part of the holding device can suppress the number of components of the apparatus and, eventually, the weight and the installation space of the apparatus.

### BRIEF DESCRIPTION OF THE DRAWINGS

FIG. 1 is a front view of a molding apparatus according to an embodiment of the invention;

FIG. 2 is a side view of the molding apparatus of an embodiment of the invention;

FIG. 3 is an enlarged structural view of an injection mechanism shown in FIG. 2;

FIGS. 4(A) to 4(F) are explanatory views illustrating a molding process according to an embodiment of the invention;

FIG. 5 is a perspective view of a bracket as an example of a product;

FIG. 6 is a plan view of the bracket;

FIG. 7 is a sectional view taken along arrow line VII-VII in FIG. 6;

FIG. 8 is a sectional view taken along arrow line VIII-VIII in FIG. 6;

FIG. 9 is a perspective view of a bracket;

FIG. 10 is a schematic sectional view of a metal rolling machine according to an embodiment of the invention;

FIG. 11 is a schematic sectional view of a forging apparatus according to an embodiment of the invention;

FIG. 12 is a schematic sectional view of a V-groove pulley manufacturing apparatus according to an embodiment of the invention;

FIG. 13 is a schematic sectional view of the V-groove pulley manufacturing apparatus of an embodiment of the invention;

FIG. 14 is a schematic side view of a vertical driller according to an embodiment of the invention.

FIG. 15 is a schematic side view of the vertical driller of an embodiment of the invention; and

FIG. 16 is a schematic sectional view of a cutting machine according to an embodiment of the invention.

### DETAILED DESCRIPTION OF EMBODIMENTS OF THE INVENTIONS

Each of the additional features and teachings disclosed above and below may be utilized separately or in conjunction with other features and teachings to provide improved molding apparatus. Representative examples of the invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teachings.

Examples will now be described with reference to the drawings.

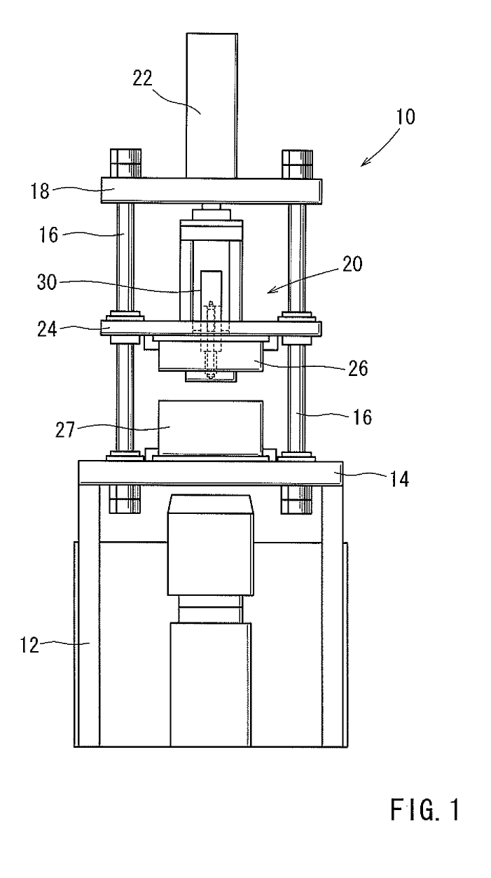

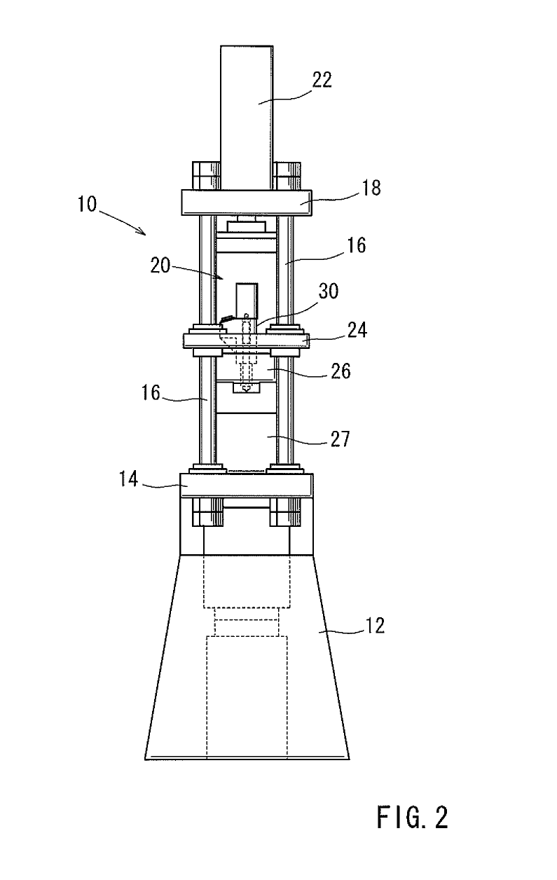

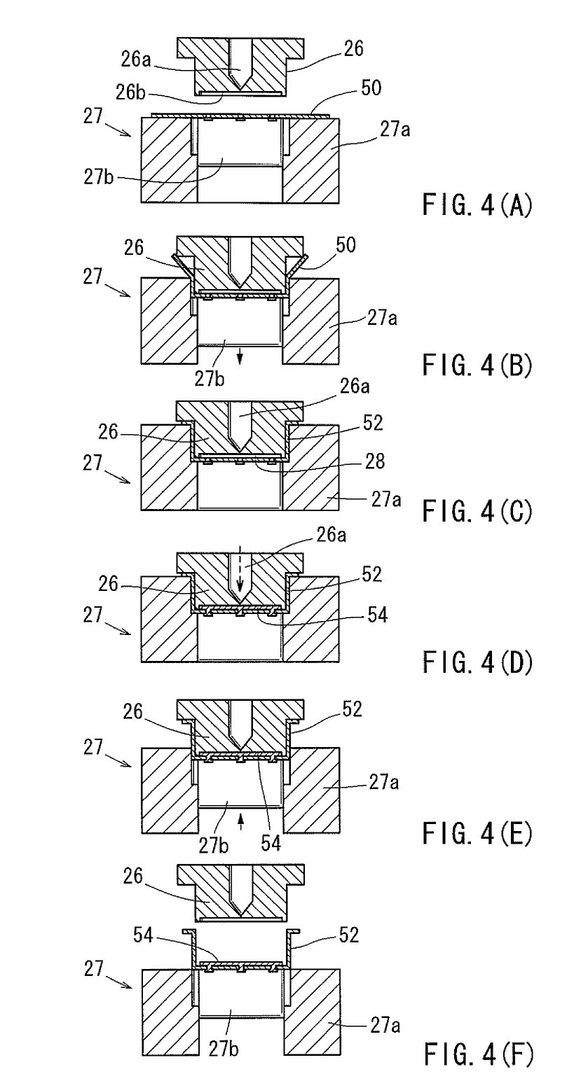

A molding apparatus shown in FIGS. 1 and 2 is equipped with a pressing machine 10 and an injection mechanism 30. The pressing machine 10 is capable of pressing (bending) a metal material 50 shown in FIG. 4, and the injection mechanism 30 is capable of heating and melting a resin material (such as elastomer) in the form of pellets and injecting the molten resin.

The pressing machine 10 is of a vertical type and has a cylinder base 18 arranged above a base 12, and a top plate 14 of the base 12 and the cylinder base 18 are connected to each other by four tie bars 16. A mold opening/closing mechanism 20 of the pressing machine 10 is equipped with a drive source 22, such as a hydraulic cylinder assembled to the cylinder base 18, and a die plate 24 movable to ascend and descend along the tie bars 16 according to the operation of the drive source 22. The mold includes an upper mold 26 fixed to the lower surface of the die plate 24, and a lower mold 27 fixed to the upper surface of the top plate 14 of the base 12.

As shown in FIG. 4, the upper mold 26 includes a resin flow path 26a for injecting molten resin by the injection mechanism 30, and a recess 26b communicating with the resin flow path 26a and defining a molding space 28 described below. On the other hand, the lower mold 27 includes a die 27a fixed to the top plate 14 of the base 12, and a slider 27b vertically movable within the die 27a.

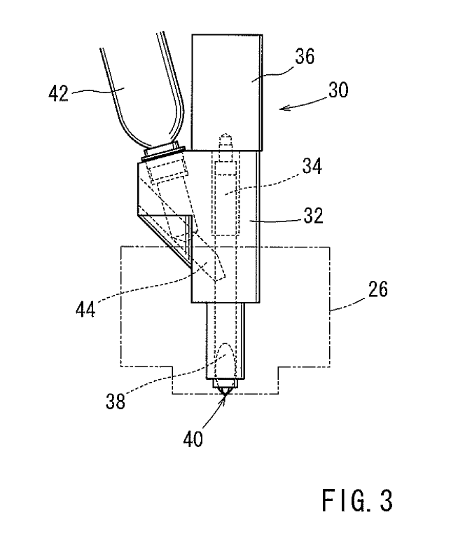

As is apparent from FIG. 3, the injection mechanism 30 is equipped with a body 32 having a hollow cylindrical configuration, and a plunger 34 is assembled within the body 32. Connected to the upper end of the body 32 is a hydraulic cylinder 36 for actuating the plunger 34, and connected to the lower end of the body 32 on the opposite side is a shut-off valve 38 communicating with the interior of the body 32. The shut-off valve 38 is disposed within the resin flow path 26a of the upper mold 26. Resin material in the form of pellets is supplied from a hopper 42 into the body 32 via a supply path 44. A heater (not shown) assembled within the body 32 heats the resin material, so that the resin material is melted or becomes molten resin.

The plunger 34 moves downwards to a position shown in FIG. 3 by the hydraulic cylinder 36, and feeds the molten resin under pressure toward the shut-off valve 38. When the shut-off valve 38 does not receive the resin pressure, it closes a gate by a piston (not shown) that is biased by a force of a spring. When the shut-off valve 38 receives the resin pressure, the piston retreats to open the gate, making it possible to inject the molten resin into the molding space 28 via a nozzle 40 disposed at the lower end. And, when the resin pressure is reduced after the molding space 28 has been filled with the molten resin, the gate recovers its original state or is closed.

If the resin material in the form of pellets ceases to flow due to a bridging phenomenon, the supply path 44, which provides communication from the hopper 42 to the interior of the body 32, serves to allow breakage the bridge by using a thin and narrow bar. Thus, so long as the resin material flows smoothly, this structure can be replaced by a structure in which the resin material is directly supplied into the body 32 from the hopper 42.

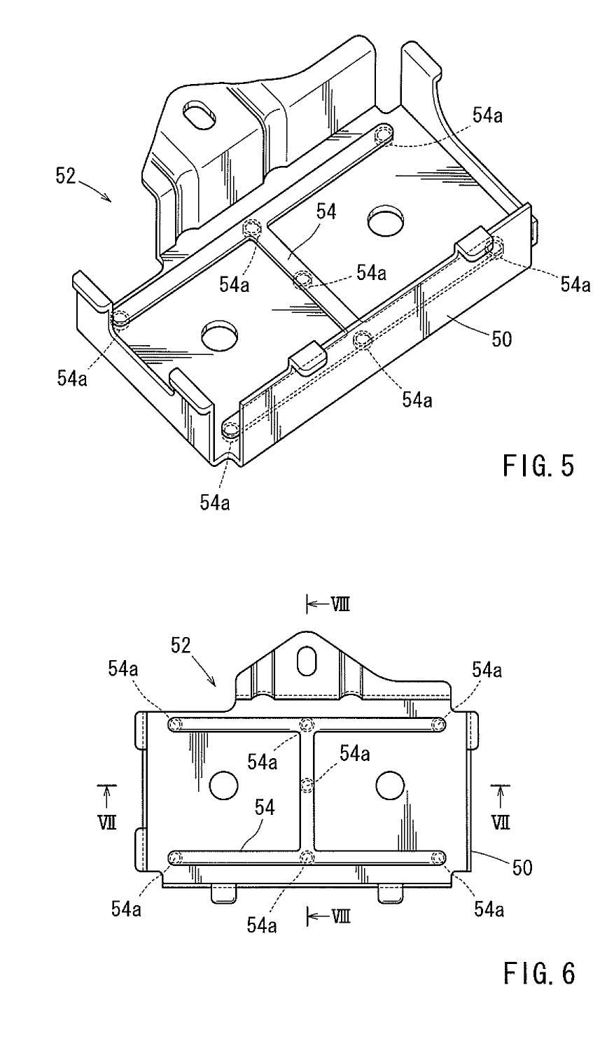

Subsequently, a process for molding a bracket 52 for a battery shown, for example, in FIGS. 5 through 8, will be described mainly with reference to FIGS. 4(A) to 4(F).

First, the plate-like metal material 50 punched to have a predetermined contour in conformity with the configuration of the bracket 52 is set on the lower mold 27 as shown in FIG. 4(A), and the drive source 22 of the mold opening/closing mechanism 20 of the pressing machine 10 is then operated to lower the upper mold 26. As a result, as shown in FIG. 4(B), the slider 27b descends together with the upper mold 26 relative to the die 27a of the lower mold 27, and a pressing (bending) operation is performed on the metal material 50. The pressing operation is completed when the upper mold 26 reaches a bottom dead center shown in FIG. 4(C).

In the state shown in FIG. 4(C), the molding space 28 is defined between the surface of the pressed metal material 50 (bracket 52) and the upper mold 26 opposed thereto by virtue of the recess 26b. The molding space 28 communicates with the resin flow path 26a of the upper mold 26 as described above, and the shut-off valve 38 of the injection mechanism 30 is disposed within the resin flow path 26a. Thus, when the hydraulic cylinder 36 actuates the plunger 34, the resin pressure is applied to the shut-off valve 38 as described above to open the gate. Therefore, the molten resin is injected into the molding space 28 via the resin flow path 26a as shown in FIG. 4(D). The molding space 28 has a configuration corresponding to the configuration of a resin member 54 to be injection-molded (see FIGS. 5 and 6).

The mold opening/closing mechanism 20 is equipped with a sensor (not shown) for detecting the mold closing state, in which the upper mold 26 has reached the bottom dead center shown in FIG. 4(C). Based on a signal from the sensor, the timing with which the injection is performed by the injection mechanism 30 is set.

After the molding space 28 has been filled with the molten resin, the apparatus is maintained in this state for approximately several seconds to cool the resin, and thereafter, the upper mold 26 and the slider 27b of the lower mold 27 are raised as shown in FIG. 4(E). And, finally, the upper mold 26 is raised back to a top dead center shown in FIG. 4(F) to complete the molding process.

As a result, it is possible to perform the pressing operation and the operation for injection molding on the metal material 50 by a single opening/closing operation of a single mold (including the upper mold 26 and the lower mold 27) of the pressing machine 10.

The bracket 52 shown in FIGS. 5 through 8 is an example of a molded product, in which the resin member 54 formed by injection molding has a configuration like an H-shaped rib in plan view. As in the case of the sheets 72 of the bracket 70 shown in FIG. 9, due to the resin member 54 of this configuration, it is possible to prevent the battery placed on the bracket 52 from movement and generating noise.

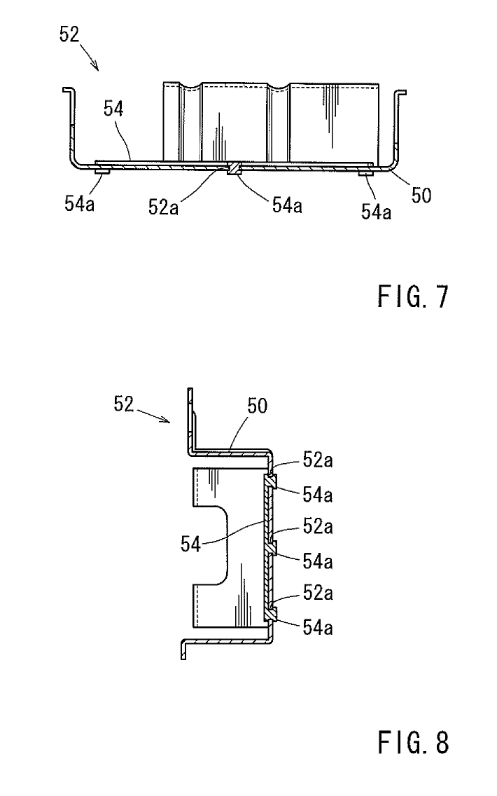

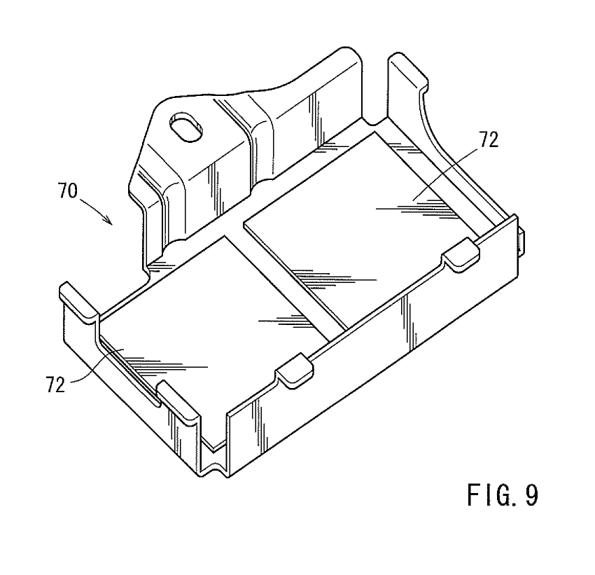

To ensure connection between the metal material 50 and the resin member 54 of the bracket 52, the molten resin can flow into a plurality of through-holes 52a formed in the metal material 50. The molten resin flown into the through-holes 52a form protrusions 54a between the back surface of the metal material 50 and the lower mold 27 (FIGS. 7 and 8). The protrusions 54a have an outer diameter larger than the inner diameter of the through-holes 52a.

From the viewpoint of preventing the battery from movement and generating noise, it is desirable to mold the resin member 54 over a range as wide as possible. However, when performing a pressing operation of the metal material 50, the through-holes 52a positioned near the bent portion may deform to hinder the flow of the molten resin. Therefore, the through-holes 52a are set at positions spaced apart from the terminal end of the rounded bent surface by approximately 4 mm. Further, also regarding the outer side portion of the bracket 52 that is not bent, in consideration of the dimensional accuracy in the pressing operation, the edge of the resin member 54 is situated at a position spaced apart from the outer contour line of the bracket 52 by approximately 2 mm, thereby preventing generation of burrs at the time of molding the resin member 54.

While the pressing machine 10 of the above example is used for bending the metal material 50, the present teaching is also applicable to any other kind of metal pressing machine, such as a stamping machine and a drawing machine, having a mold including an upper mold and a lower mold corresponding to the upper mold 26 and the lower mold 27, respectively.

While in the above example, the resin flow path 26a is provided in the upper mold 26 in FIG. 4, it is possible to arrange the injection mechanism 30 as it is in a portion of the resin flow path 26a. Further, it is also possible to provide a resin flow path in the lower mold 27 for injection molding of resin on a side surface of the bracket 52. Furthermore, as disclosed, for example, in Japanese Laid-Open Utility Model Publication No. 07-009585, by incorporating the apparatus of the above example into one or both of two press forming dies arranged vertically, it is possible to perform three to four machining steps in a single machining cycle.

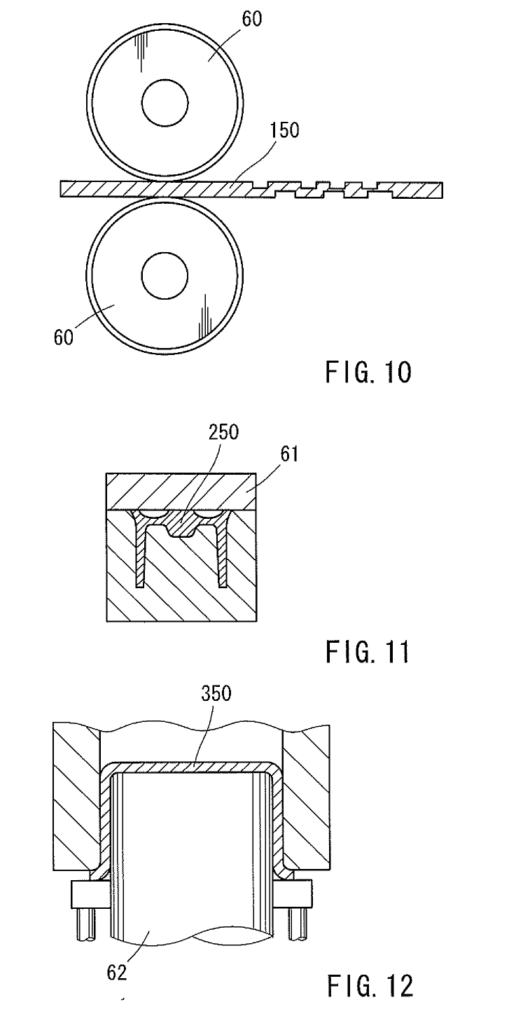

A metal rolling machine disclosed, for example, in Japanese Laid-Open Patent Publication No. 05-092693, is substantially of the same construction as that shown in FIG. 10. The injection mechanism 30 may be incorporated into one of a pair of upper and lower rotary rolls 60, whereby it is possible to perform an injection molding of resin substantially simultaneously with rolling operation of a metal material 150. Since the rotary rolls 60 rotate, it may not be sufficient to simply incorporating the injection mechanism 30 into the roll(s) 60. However, by preventing the injection mechanism 30 from rotating with the roll(s), and allowing injection only when it communicates with a resin flow path provided in the rotary roll 60, the above function can be achieved. Further, after a rolling operation has once been performed, the rotary rolls 60 may be rotated in a reverse direction to return to a suitable rotational position for performing a resin molding operation, and an injection molding operation of resin may then be performed.

With this arrangement, it may be possible to obtain not a coin or medal simply having protrusions and recesses but one decorated with resin.

An apparatus for forging a wheel of an automobile is disclosed, for example, in Japanese Laid-Open Patent Publication No. 06-218481, is substantially of the same construction as the one shown in FIG. 11. In this construction, by incorporating the injection mechanism 30 into a forging die 61, it is possible to perform an injection molding operation of resin along with an operation for forging metal. Since the forging operation is completed substantially instantaneously, it is necessary to cause the forging die 61 to interact with a tertiary material 250 again. As a result, as compared with the case in which no injection molding operation is performed, the time necessary for processing may be longer. However, there is no need to use a dedicated equipment for an injection molding operation, and the processing time is shorter than in the case in which the forging operation and the injection molding operation are performed by separate units of equipment. Further, the installation space required for the equipment may be small, and moreover, there is no need of additional operations, such as an operation for transferring a material to be processed, for performing the injection molding operation.

This makes it possible to decorate an automotive wheel through the injection molding operation of resin in addition to the forging operation.

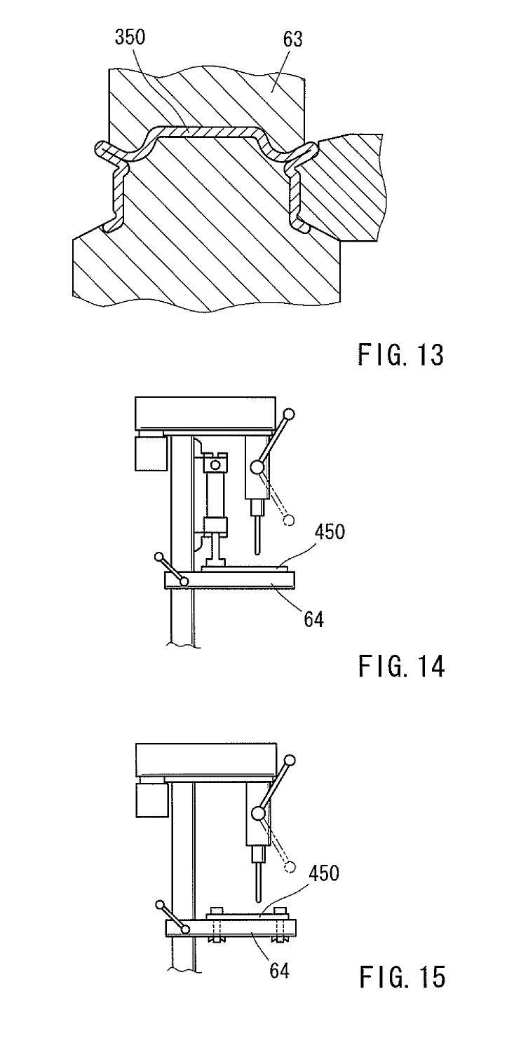

An apparatus for manufacturing a multi-grooved V-pulley made of a metal plate is disclosed, for example, in Japanese Laid-Open Patent Publication No. 07-116760, and has substantially the same construction as shown in FIG. 12 or FIG. 13. In the construction shown in FIG. 12, by incorporating the injection mechanism 30 into an inner die 62, it is possible to perform an injection molding operation of resin along with an operation for drawing a metal material 350.

In the construction shown in FIG. 13, by incorporating the injection mechanism 30 into a rotary upper die 63, it is possible to perform an injection molding operation of resin in addition to a form rolling operation of the metal material 350. Since the rotary upper die 63 rotates, it is rather difficult to achieve the above function by simply providing the injection mechanism 30 within the rotary upper die 63. However, by preventing the injection mechanism 30 from rotating with the rotary upper die 63 and allowing the injection mechanism 30 to inject resin only when the rotation of the rotary upper die 63 is stopped, it is possible to perform an injection molding operation of resin in relation to the form rolling operation.

This makes it possible to perform an injection molding operation of resin on a flat portion, which is a mounting portion of a multi-grooved V-pulley made of a metal plate.

A vertical driller is disclosed, for example, in Japanese Laid-Open Patent Publication No. 07-308810, and has substantially the same construction as shown in FIG. 14 or 15. In the construction shown in FIG. 14 or 15, by incorporating the injection mechanism 30 into a table 64, it is possible to perform an injection molding operation of resin on a material 450 to be machined in addition to a drilling operation of the material 450.

In this example, the material 450 to be machined does not move during the drilling by the driller, so that it is advantageously possible to perform the injection molding operation simultaneously with the drilling operation.

Further, even before the drilling operation, the material 450 to be machined is fixed in position on the table 64, so that it is also possible to perform the injection molding operation prior to the drilling operation.

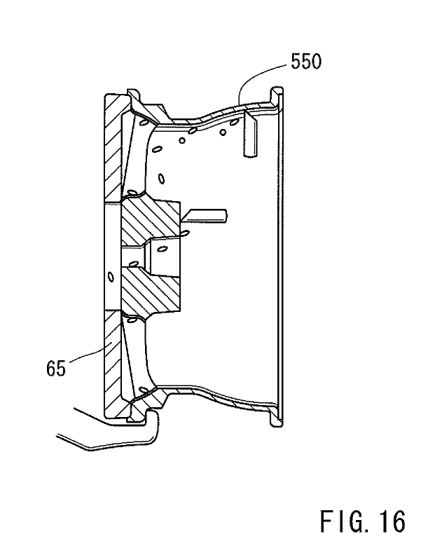

A wheel cutting machine is disclosed, for example, in Japanese Laid-Open Patent Publication No. 11-239901, and has substantially the same construction as the construction shown in FIG. 16. In the construction shown in FIG. 16, by mounting the injection machine 30 to a work support plate 65, it is possible to perform a resin molding operation on a light alloy wheel material 550 in addition to the cutting operation of the material 550. During the cutting operation, the work support plate 65 is rotating, so that it is impossible to perform an injection molding operation simultaneously with the cutting operation. However, by providing the work support plate 65 with a resin flow path and arranging the injection mechanism 30 so as to communicate with the resin flow path when the rotation is stopped, it is possible to perform the resin injection molding operation in addition to the cutting operation. Thus, although the time required for processing may become longer as compared with the case in which no injection molding operation is performed, there is no need to provide dedicated equipment for the injection molding operation, and, as compared with the case in which the cutting operation and the injection molding operation are performed by separate units of equipment, the processing time is shortened, and the space required for installation of the equipment becomes smaller. Further, there is no need of additional operations, such as an operation for transferring a material to be processed, for performing the injection molding operation.

This makes it possible to decorate an automotive wheel through the injection molding operation of resin in addition to the cutting operation.

In this example, it is also possible to perform the injection molding operation prior to the cutting operation.

As described in above examples, if a machining apparatus has a holding device, such as a mold or various types of jigs, which holds a material, a part of the holding device necessarily contacts a portion of the material, which is not intended to be machined. Therefore, by utilizing such a portion, it is possible to perform a injection molding operation of resin in addition to the machining operation.

As examples of the machining operations, there have been described bending, rolling, forging, drawing, form rolling, drilling, and cutting operations of a metal material. However, the present teaching is also applicable to any other type of machining apparatus, such as polishing, grinding, blasting, cutting, and punching apparatus, as long as they have a holding device that holds the material.

Further, the present teaching can be used for processing any material, such as wood, resin molded product, paper, ceramic, plaster, or mineral material, other than the metal material, which can be machined or processed by the above machining apparatus.

1. A molding apparatus for performing a predetermined machining operation on a material and performing an injection molding operation of resin on a surface of the material, comprising:
a machining mechanism for performing the predetermined machining operation, the machining mechanism including a holding device for holding the material when the predetermined machining operation is performed on the material,
a mold member arranged to be opposed to the surface of the material in a state in which the material is held by the holding device in order to perform the predetermined machining operation, so that a molding space for molding the resin is defined between the surface of the material and an inner surface of the mold member,
a resin flow path communication between the exterior of the molding space and the molding space, and
an injection mechanism capable of injecting molten resin into the molding space via the resin flow path.

2. The molding apparatus as in claim 1, wherein the mold member is constituted by a part of the holding device.
